(19) United States
(12) Patent Application Publication
(10) Pub. No.: US 2010/0086375 A1
(43) Pub. Date: Apr. 8, 2010

(54) Wheelchair Passenger Securement Station

(76) Inventors: Jules TREMBLAY, Ocean Ridge, FL (US); Erick Rudaitis, Sterling Heights, MI (US); Paul Slevinsky, Brampton (CA); Dale Drew, Grosse Pointe Farms, MI (US)

Correspondence Address: DAVID I. ROCHE;BAKER & MCKENZIE LLP, 130 EAST RANDOLPH DRIVE, CHICAGO, IL, 60601, US

(21) Appl. No.: 12/573,770

(22) Filed: Oct. 5, 2009

Related U.S. Application Data
(63) Continuation-in-part of application No. 11/861,268, filed on Sep. 25, 2007.
(60) Provisional application No. 60/846,958, filed on Sep. 25, 2006.
(60) Provisional application No. 61/102,861, filed on Oct. 5, 2008.

(51) Int. Cl. B61D 3/18; B60P 3/06; A61G 5/10

(52) U.S. Cl. 410/7

(57) ABSTRACT

The inventions described and claimed herein are systems or components for an automated rear-facing wheelchair passenger station and include a forward excursion barrier for preventing forward movement of a wheelchair, lateral excursion barriers for preventing undesired movement of a wheelchair, and an electro-pneumatic control system.

### CROSS-REFERENCE TO RELATED APPLICATIONS

This application claims priority to U.S. Provisional Patent Application No. 61/102,861 filed on Oct. 5, 2008; and is a continuation-in-part application of U.S. patent application Ser. No. 11/861,268, filed on Sep. 25, 2007, which claims priority to U.S. Provisional Patent Application No. 60/846,958, filed on Sep. 25, 2006. U.S. patent application Ser. No. 11/861,268 and U.S. Provisional Patent Application Nos. 61/102,861 and 60/846,958 are incorporated herein by reference.

### FIELD OF THE INVENTIONS

The inventions described and claimed herein relate generally to wheelchair securement devices for transport vehicles. One specific embodiment of the inventions described herein relates to a rear facing wheelchair passenger station for securing a wheelchair in a large accessible transit vehicle (train, bus, van, plane, etc.).

### BACKGROUND OF THE INVENTIONS

The present inventions are generally related to providing adequate wheelchair securement in large accessible transport vehicles (referred to herein as “LATVs”). LATVs are transport vehicles which are designed for use by both seated and standing passengers. The Americans with Disabilities Act (ADA) mandates that all public transit service providers must accommodate persons with disabilities, including those who must use a wheelchair as their seat in the transport vehicle. ADA also mandates that, for the safety of the wheelchair user and near-by passengers, the wheelchair must be secured so that it will not move more than 2″ in any direction during normal vehicle operation. In addition, occupant restraint belts must also be made available in the wheelchair stations, but there is no requirement that they be used.

Although four-point securement straps that meet these requirements are the norm in today's LATVs in the US, a number of pressing problems remain with the prior art four-point strap-type securement technology. For example, the prior art devices are difficult to apply, especially on the wall side of the vehicle. Also, the LATV operator (“operator”) must leave the driver's station to attach the prior art devices, which not only significantly increases the dwell times at stops but also requires the operator to encroach into the wheelchair passenger's personal space. As a result, the prior art devices are often misapplied, or worst still, are not used at all. Most importantly, the prior art securement approach also means that wheelchair passengers do not have independent access to public transportation equal to that of all other passengers.

In Europe and Canada, rear-facing wheelchair passenger stations (referred to herein as “RF-WPSs”) are quickly becoming accepted and, in Europe, RF-WPSs are now the norm for LATVs. The RF-WPSs are passive in that the RF-WPSs do not physically connect the wheelchair to the vehicle, and instead rely upon various barriers to control wheelchair movement. Typically, the barriers located within a RF-WPS include a rear-facing padded bulkhead (also termed forward excursion barrier (“FEB”)) against which the wheelchair is backed. The FEB is intended to prevent forward movement of the wheelchair in the vehicle when it is braking. On the aisle-side of the WPS there is often a floor-to ceiling stanchion (steel tube) barrier, that is intended to prevent rotation or tipping of the wheelchair towards the aisle (laterally) during vehicle turns. Some installations do not include a lateral barrier (stanchion), therefore placing the wheelchair at high risk of tipping or swerving into the aisle.

The prior art RF-WPSs are not designed to handle crash magnitude forces and instead are only concerned with forces which are expected to be generated during emergency driving events, such as maximum braking or swerving. This approach assumes that, because of the relative safety of LATVs used in fixed route service, it is highly unlikely that LATVs carrying wheelchair users will be in a vehicle collision. Based upon research studies involving emergency driving of LATVs, the maximum deceleration force which may be encountered during emergency driving events is believed to be less than 1 g.

The RF-WPS concept has the potential of resolving many of the problems of the prior art four-point strap-type devices, in that the wheelchair user gains independent use of public transportation, the operator can remain in the drivers station (reducing or eliminating driver injuries related to wheelchair passenger securement), and bus stop dwell times are reduced. However, there are still several problems with the prior art RF-WPSs. For example, it is understood that the prior art RF-WPSs allow wheelchairs to move in excess of 2″ during severe driving conditions, which may cause some types of wheelchairs to tip or swing into the aisle. As a result, auxiliary securement straps attached by drivers are required to prevent such tipping, which nullifies one of the main goals and advantages of the RF-WPS concept—user independence. Also, prior art devices do not allow a close proximity fit between the wheelchair occupant and the FEB, which increases the injury risk in the event of panic breaking or a frontal collision. Finally, prior art lateral barrier installations often protrude into the center bus aisle creating passenger flow problems, as well as maneuvering problems for a second wheelchair passenger.

### SUMMARY OF THE INVENTIONS

The wheelchair passenger stations (WPS) described and claimed herein solve at least some of the problems of the prior art rear facing wheelchair passenger stations by: limiting wheelchair movement in all directions, including tipping into the aisle; removing the need for auxiliary strap(s), providing closer proximity between the user and the FEB, and relocating the lateral barrier, thereby providing much improved wheelchair maneuverability, as well as routine passenger flow down the middle aisle.

The wheelchair passenger station described herein is adapted to be a complete stand-alone “drop-in” wheelchair station for LATVs. However, it is contemplated that various components of a wheelchair passenger station may be incorporated piecemeal into LATVs, as opposed to a “complete drop-in” system.

Note that, although the present inventions are described herein with reference to LATVs, which could include large transit buses, commuter train cars, and the like, the present inventions are not intended to be limited to such application. Indeed, at least some of the claims herein are directed to wheelchair passenger stations for vehicles, generically, and not specifically to LATVs.

Although not limited as such, the wheelchair passenger station is intended to fit into the current ADA 48″×30″ minimum wheelchair space, which is required for all LATVs in the US. One embodiment of the wheelchair passenger station described herein provides containment for an occupied wheelchair primarily through use of three integrated components: a forward excursion barrier and two lateral excursion barriers, one fixed to one side of the forward excursion barrier and the other fixed to the opposite side of the forward excursion barrier. Other embodiments include some combination of above with other components described below, shown in the figures, and described and shown in the priority applications (application Ser. Nos. 11/861,268 and 60/846,958), such as a control system, warning lights, audible warning system, hand-holds, high friction floor material and/or other components.

The forward excursion barrier resists forward movement of a wheelchair and is intended to serve as the wheelchair stop and/or occupant head restraint during emergency braking events. In the shown embodiments, the forward excursion barrier provides head and back support and is mounted in the front area of the wheelchair passenger station. The lateral excursion barriers engage with opposing sides of the wheelchair to prevent excessive lateral movement and tipping during vehicle swerving events. In the shown embodiment, the lateral barriers are directly connected to and depend from the forward excursion barrier and are electro-pneumatically activated. More specifically, the shown embodiments constitute movable arms that have independently movable hands and fingers that secure the wheelchair to prevent movement. Even more specifically, the lateral excursion barriers include projections or fingers which frictionally engage and/or mechanically interlock with the wheelchair components to prevent rearward movement of the wheelchair during the “rebound” of emergency braking events. In addition, the depicted lateral barriers stow in such a manner so as to allow easy access into the station by wheelchair passengers and to not impede the safe use of a wall-side mounted fold-down seat in the wheelchair passenger station by other passengers when no wheelchair is present.

### BRIEF DESCRIPTION OF THE DRAWINGS

These and other features, aspects, objects, and advantages of the inventions described and claimed herein will become better understood upon consideration of the following detailed description, appended claims, and accompanying drawings where:

FIG. 1 is a perspective view of a first embodiment of a wheelchair passenger station configured in a park (or stored) position;

FIG. 2 is a side view of the same embodiment configured in the park position;

FIG. 3 is a perspective view of the same embodiment configured for receiving a wheelchair, in a wheelchair ready position;

FIG. 4 is perspective view of the same embodiment configured between the wheelchair ready position and a wheelchair secured position;

FIG. 5 is a side view of the same embodiment configured between the wheelchair ready position and the wheelchair secured position;

FIG. 6 is a perspective view of the same embodiment configured in the wheelchair secured position;

FIG. 7a is a side view of the same embodiment in the wheelchair secured position, securing a rear-wheel drive wheelchair;

FIG. 7b is a side view of the same embodiment in the wheelchair secured position, securing a scooter wheelchair;

FIG. 7c is a side view of the same embodiment in the wheelchair secured position, securing a front-wheel drive wheelchair;

FIG. 7d is a side view of the same embodiment in the wheelchair secured position, securing a mid-wheel drive wheelchair;

FIG. 8 is a first embodiment of a control panel for the vehicle operator, which may be mounted in the drivers station;

FIG. 9 is a first embodiment of a control panel for the wheelchair passenger, which may be mounted on the underside of the wall-side oriented flip-seat;

FIG. 10 is a cross sectional view of the same embodiment with the shoulders of the lateral barriers in the extended position, revealing the mechanism for laterally moving the shoulders;

FIG. 11 is a cross-sectional view of a first embodiment of the forward excursion barrier with the lateral barriers positioned in the extended position, revealing the mechanism for rotating the lateral barriers;

FIG. 12 is a side view of the same embodiment with the hands in the lowered/extended position, and with the arm cover panel removed to reveal the mechanism for moving the hands;

FIG. 13 is a cross sectional view of the hands of the same embodiment to reveal the mechanism for biasing the fingers in an extended position;

FIG. 14 is an air circuit diagram for a first embodiment of a control system for the wheelchair passenger station; and,

FIG. 15 is a system level architecture diagram of the same embodiment of the control system;

FIG. 16 is a front view of a second embodiment of the forward excursion barrier, with the lateral excursion barriers removed for clarity purposes.

It should be understood that the drawings are not necessarily to scale and that the embodiments are sometimes illustrated by graphic symbols, phantom lines, diagrammatic representations and fragmentary views. In certain instances, details which are not necessary for an understanding of the inventions described and claimed herein or which render other details difficult to perceive may have been omitted. It should be understood, of course, that the inventions described herein are not necessarily limited to the particular embodiments illustrated herein.

Like reference numerals will be used to refer to like or similar parts from Figure to Figure in the following description of the drawings.

### DETAILED DESCRIPTION OF THE DRAWINGS

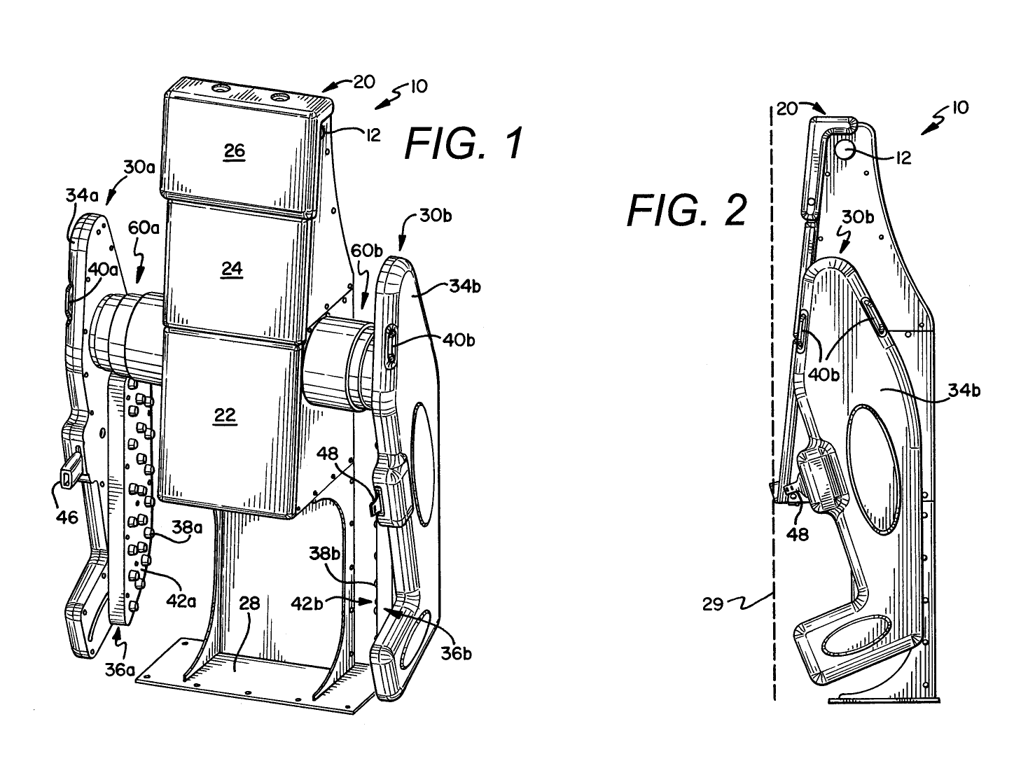

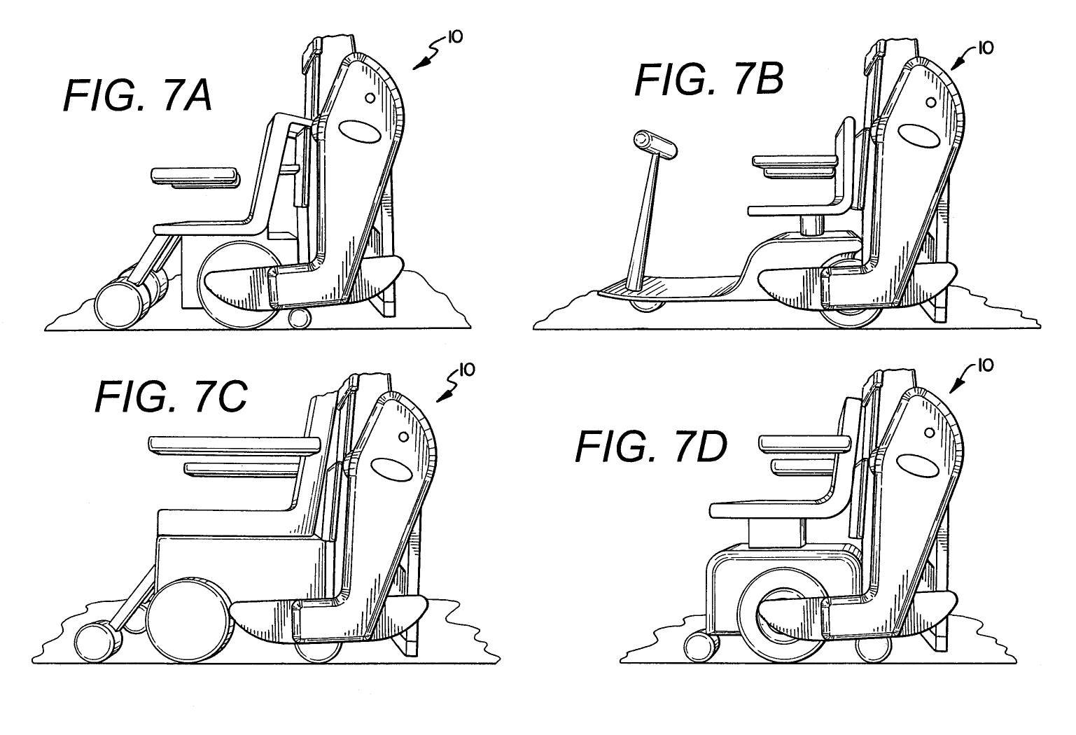

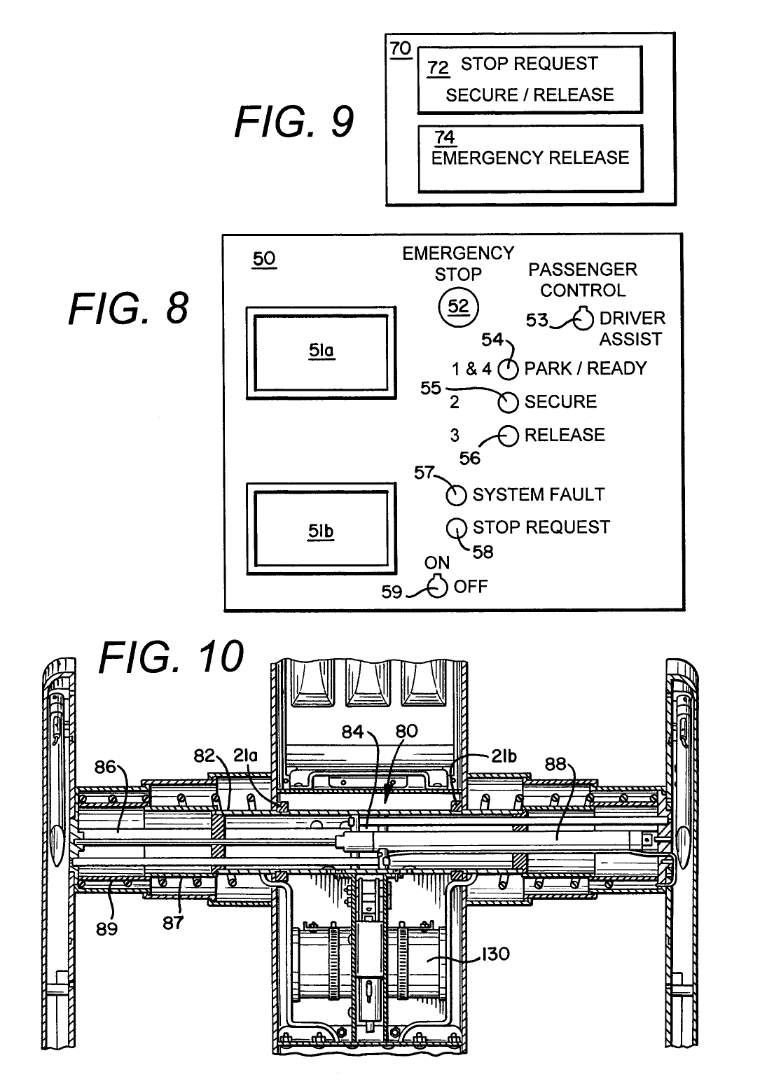

FIGS. 1-6 represent a first embodiment of a wheelchair passenger station 10 in various configurations, starting with a park (or stored) position in FIG. 1, and ending with a wheelchair secured position in FIG. 6. In FIGS. 1-6, the wheelchair was omitted for purposes of clarity. FIGS. 7A-7D show various wheelchair types and designs in a secured position, which demonstrates the flexibility of the WPS to adequately secure all common sizes, types, and configurations of wheelchairs. Finally, FIGS. 8-15 represent a first embodiment of a control system for the wheelchair passenger station, including control panels for the vehicle operators and wheelchair passenger, mechanisms for manipulating the various components of the wheelchair passenger station between the park position and the wheelchair secured position, an air circuit for powering the mechanisms, and an architecture diagram for the control system. Other embodiments of the wheelchair passenger station are described in the priority applications, which have been incorporated herein by reference.

With reference first to the wheelchair passenger station depicted in FIGS. 1-6, the wheelchair passenger station 10 in general comprises a forward excursion barrier 20 and two lateral excursion barriers 30. The forward excursion barrier 20, as depicted, includes three sections, a lower back rest 22, a mid back rest 24, and an upper backrest 26. The lower back rest 22 is adapted to engage with the lower rear seat level of the wheelchair (not shown) to correctly position the wheelchair for proper engagement with the lateral excursion barriers 30, the mid back rest is adapted to restrain the wheelchair passenger's back during emergency driving events, and the upper back rest 26 is adapted to restrain the wheelchair passenger's head during emergency driving events, wherein the wheelchair passenger would be subject to forwardly directed forces (i.e., in the direction of travel of the vehicle). In at least some embodiments, the forward excursion barrier can serve as a stand-sit support surface for a standing passenger when a wheelchair is not in the wheelchair passenger station. The forward excursion barrier 20 preferably comprises high density polyurethane foam similar to car head rests, although the invention is not limited as such. Another option would be to have the forward excursion barrier 20 fabric covered in the lower, mid, and upper back rests 22, 24, and 26 without the use of a cushion. This option presents a more vandalism resistant design.

In an alternate embodiment, the backrest, and most likely the upper backrest 26, may be adjustable, either manually or automatically. The adjustment of the upper backrest 26 may be in the horizontal or vertical direction to better fit the individual passenger needs. In one embodiment, the upper backrest (or headrest) 26 could move to reduce the distance between the passenger and the headrest to reduce the risk of whiplash during a frontal accident. Such a system would be beneficial, since the possibility exists that the passenger will not place their wheelchair fully against the back support. Moreover, some passengers carry backpacks or other items on the backs of their wheelchairs preventing them from being fully positioned against the back support.

The upper backrest 26 may automatically sense, though the use of sensors such as ultrasonic or inferred), the position of the wheelchair passenger's head and adjust accordingly. Once the distance between the headrest and the passenger is measure, the headrest would move a set distance away from the passenger. The headrest can be moved by inflating an airbag or by using an electric actuator or air cylinder.

The upper backrest 26 may also include a speaker 12 (for audible warnings and/or directions). The speaker 12 may be also disposed on another component of the wheelchair passenger station 10 or even on another component of the LATV. In an alternate embodiment, the backrest of the forward excursion barrier 20 may be a continuous surface.

The wheelchair passenger station 10 is secured to the LATV (not shown for clarity purposes) by a pedestal base 28 via mechanical means (not shown) known to one skilled in the art. Examples of mechanical means include, but are not limited to, lag bolts, screws, posts, columns, hook and pile fasteners, mechanical fasteners, and the like.

In the shown embodiment, there are two lateral excursion barriers, a right lateral excursion barrier 30a and a left lateral excursion barrier 30b, constituting a right arm 34a and a left arm 34b connected to the forward excursion barrier 20 by a right shoulder 60a and a left shoulder 60b. Connected to and depending from the right arm 34a and left arm 34b are a right hand 36a and left hand 36b. The inner-facing surfaces of the right hand 36a and left hand 36b constitute a right palm 42a and a left palm 42b, from which a plurality of right fingers 38a and left fingers 38b protrude. For simplicity purposes, the terms arm, shoulders, hands, and fingers are used herein to refer to the various structures constituting the lateral excursion barriers. To the extent that these terms connote a particular shape and configuration for the lateral excursion barriers (e.g., that the lateral excursion barriers resemble human appendages), the claims are not intended to be limited as such unless specifically called out in the claims.

In one embodiment, the right lateral excursion barrier 30a will be closest to the wall of the LATV and the left lateral excursion barrier 30b will be closest to the aisle of the LATV. In another embodiment, the wheelchair passenger station 10 could be mounted in an opposite side of the vehicle, whereby the positions of the lateral excursion barriers 30 relative to the aisle and wall would be reversed. Although omitted for clarity purposes, the wheelchair passenger station could include a side seating module positioned along the wall side of the station 10. The side seating module could include a fold-down seat that would be in the up positioned when the station is used for a wheelchair passenger and would be in the down position when a wheelchair passenger is not onboard. See, for example, FIGS. 1-2 of U.S. patent application Ser. No. 11/861,268 (which has been incorporated by reference), which generally shows the configuration referred to herein.

For purposes of brevity, the right and left later excursion barriers are referred to collectively. It should be noted that the left lateral excursion barrier 30b has substantially all the same parts orientated in a mirror image of the right lateral excursion barrier 30a. Parts ending in the suffix “a” will be for the components of the right lateral excursion barrier 30a while parts ending in the suffix “b” will be for the components of the left lateral excursion barrier 30b. When referring to the components of the right and left lateral excursion barriers, the suffix will be omitted (e.g., when referring to the right palm 42a and the left palm 42b collectively, the reference numeral “42” will be used.

The shoulders 60 are configured to extend from and retract towards or into the forward excursion barrier 20. The shoulders 60 cover the internal machine parts for extending and refracting the shoulders 60 between the park position, the wheelchair ready position, and the wheelchair secured position. In the shown embodiment, the shoulders 60 includes a set of nesting or telescoping cylinders having outer extenders 62, intermediate extenders 64, and inner extenders 66. Other structures can be used for the shoulders 60. For example, alternative embodiments could use expandable, accordion-style, tubular structures, or could exclude the shoulders whereby the internal machine parts would be exposed. Although not limited as such, the shoulders 60 move in a horizontal plane.

The shoulders 60 are connected to the arms 34. The arms 34 include a hands 36a and a plurality of fingers 38. The arms 34 are adapted to include an occupant restraint belt to restrain rearward movement of the wheelchair occupant. The occupant restraint belt preferably comprises a female connector 46 and a male connector 48. The male connector 48 preferably includes a belt and a refractor. The male connector 48 is interconnected to the left arm base 34b and the female connector 46 is interconnected to the right arm 34a, although such configuration may be reversed. It is contemplated that the belt and refractor may be attached to either the male connector 48 or the female connector 46. Alternatively, both the male connector 48 and the female connector 46 could both include belts and retractors.

The arms 34 further include warning lights 40 which in some embodiments operate in conjunction with audible warnings from the speaker 12 to warn passengers of imminent movement of the lateral excursion barriers 30, although it is contemplated that the warning light may be disposed on another component of the wheelchair passenger station 10 or even on another component of the LATV. In some embodiments, the warning light 40a may include a red warning light and a yellow warning light to be used for different operations of the wheelchair passenger station 10.

The arms 34 are further connected to the hands 36. As shown, the hands 36 are stored in a substantially vertical position. Although not shown, the hands 36 may be adapted to “drop” into a recessed portion or socket in or on the floor of the LATV when the wheelchair passenger station 10 is configured in the park position to provide added stability to the lateral excursion barriers 30 and to minimize movement.

As described in more detail below, the arms 34 include a set of tracks (or cams) 40, which engage with corresponding cam followers on the hands 36, for guiding the hands 36 from the park position to the wheelchair secured position. The lateral excursion barriers 30 are adapted to not only extend laterally from the forward excursion barrier 20 via the shoulders 60 but also rotate about the shoulders 60. The hands 36 are adapted to move by rotation and by linear movement from a substantially vertical position to a substantially horizontal position. In the horizontal position, the hands provide a broad expanse which allows for compatibility with many different types and designs of wheelchairs.

The hands 36 includes a plurality of fingers 38. As shown, the fingers 38 are capable of retracting when pushed against an object, such as a wheelchair wheel. The fingers 38 may include a biasing means, such as a spring, for biasing the fingers 38 in an extended position. The hands 36 also include palms 42. The palms 42 may be made of steel plate or sheet metal, or an abrasion resistant, high-friction, elastomeric material (with or without a covering or upholstering) so as not to damage the wheelchair and provide maximum resistance to wheelchair movement relative to the vehicle.

As discussed in more detail below, the right arm shoulder 60a and the left arm shoulder 60b are preferably interconnected to the forward excursion barrier 20 by a electro-pneumatically activated mechanism which is adapted to extend and retract the shoulders 60 laterally from the forward excursion barrier 20, and to rotate the arms 34 about an axis extending along the longitudinal axis of the shoulders 60. The hands 36 are interconnected to an electro-pneumatically activated mechanism, which is adapted to move the hand between a raised and generally vertical position and a lowered and generally horizontal position. The right arm shoulder 60a is preferably controlled in concert with the left arm shoulder 60a so that they engage simultaneously and exert a pre-determined equal (or approximately equal) and opposite force on the wheelchair.

To provide adequate securement of a wheelchair, it is desirable that lateral excursion barriers 30 be able to provide approximately 50 lbs of force on both the right side wheel of the wheelchair and the left side wheel of the wheelchair, although similar results may be obtained with more or less force. The force will be applied by the refraction of the right shoulder 60a and the left shoulder 60b and will be exerted at wheelchair contact points on the palms 42 and/or fingers 38.

With reference now to FIGS. 1 and 2, the wheelchair passenger station 10 is configured in the park or stored position, wherein the lateral excursion barriers 30 are fully refracted. That is, shoulders 60 are fully refracted (providing a minimum width for the station), the arms 34 are rotated back (towards the front of the vehicle), and the hands 36 are stored in a vertical position. In this configuration, the wheelchair passenger station 10 presents a reduced footprint, thereby minimizing the amount of space being occupied in the LATV, and can be configured with side seating for use by non-wheelchair passengers.

With particular reference to FIG. 2, a side view of the wheelchair passenger station 10 in the park position, the forward excursion barrier 20 presents a forward excursion boundary or plane 29. In the park position, at least a substantial portion of the lateral excursion barriers 30 are positioned behind the forward excursion plane 29 (towards a front of the vehicle). With this configuration, tripping hazards are minimized and the lateral excursion barriers 30 do not provide an obstacle for the lowering of a flip seat.

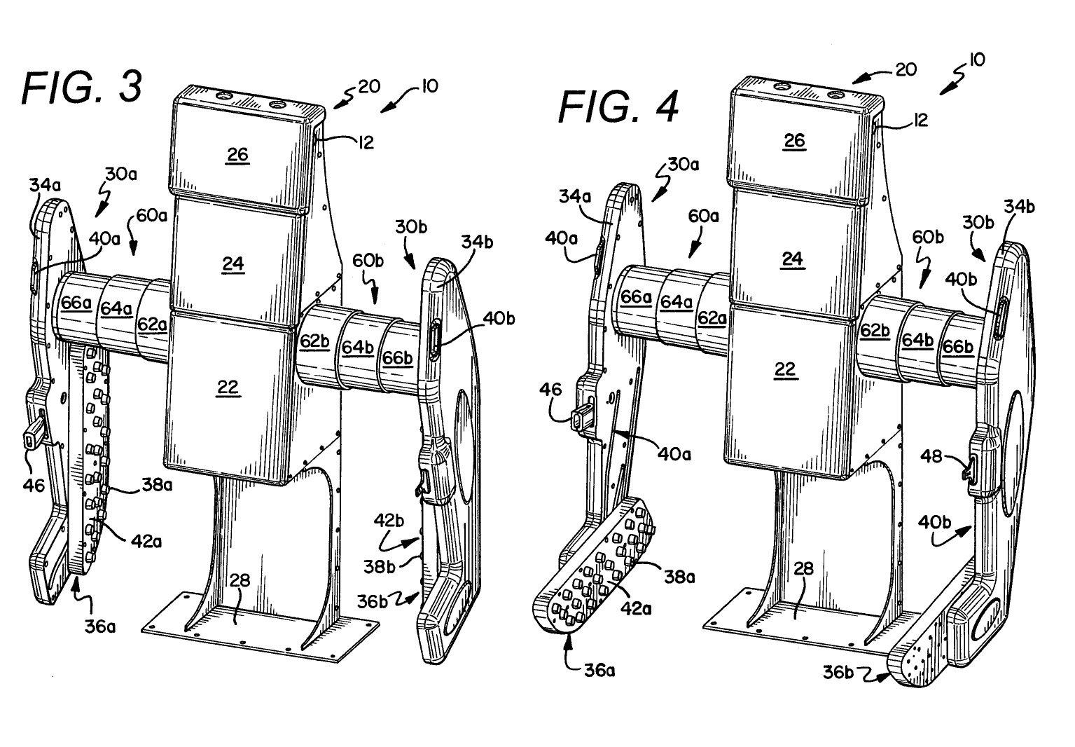

Turning now to FIG. 3, the wheelchair passenger station 10 is configured in the wheelchair ready position wherein the arms 34 have deployed laterally from the forward excursion barrier (i.e., the shoulders 60 are extended). The lateral excursion barriers 30 present a maximum width for the station 10 to allow for easy and convenient entrance into the station 10 by wheelchair passengers. This configuration represents the first step in the wheelchair securement process. It should be noted that at this stage, the lateral excursion barriers have not rotated forward, and are still disposed behind the forward excursion plane 29. In that respect, wheelchair passengers can back into or otherwise enter the wheelchair passenger station directly from the aisle. At this stage, none of the components of the wheelchair passenger station 10, including the lateral excursion barriers 30, block lateral access into the station 10 from the aisle of the vehicle.

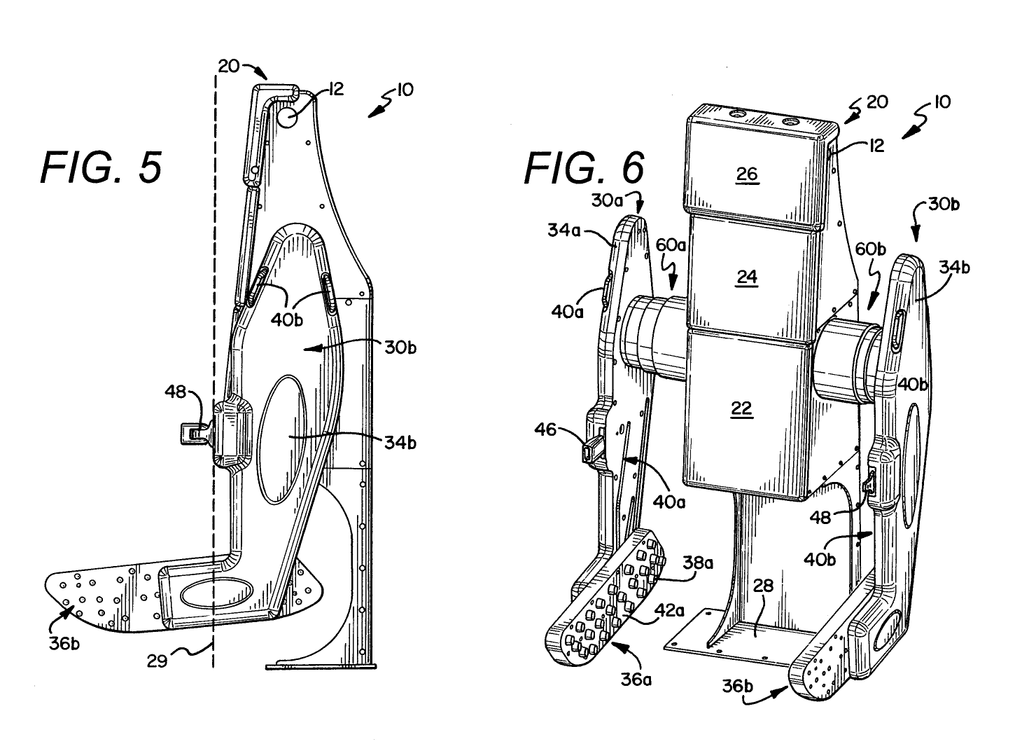

With reference now to FIGS. 4 and 5, the wheelchair passenger station is shown configured in an intermediate position between the wheelchair ready position and the wheelchair secured position. It should be noticed that the arms 34 have rotated forward and the hands 36 have dropped into the lowered, generally horizontal position, whereby the hands 36 would be properly aligned for engagement with the wheelchair. In other words, the hands 36 are in the appropriate position to enable the palms 42 and fingers 38 to engage the wheelchair, preferably at the wheels. At this stage, substantial portions of the lateral excursion barriers 30 have crossed the forward excursion plane 29. Although not shown, by this stage, a wheelchair passenger would be present in the station 10, with the back of the wheelchair positioned against the backrest of the forward excursion barrier. With the shoulders 60 of the lateral excursion barriers fully extended, the hands 36 of the lateral excursion barriers 30 would be laterally spaced from opposing sides of the wheelchair.

Finally, with reference to FIG. 6, the wheelchair passenger station 10 is shown in the wheelchair secured position. To get to this configuration, the shoulders 60 have refracted, thereby urging the palms 42 and fingers 38 of the hands 36 into engagement with the wheelchair. Note, however, that since wheelchair has been removed from the figures for clarity purposes, the shoulders are shown fully refracted. In use, the shoulders would rarely fully retract, and instead would retract only enough to allow sufficient compressive force to be exerted on the wheelchair by the hands 36. The internal mechanisms allow the lateral excursion barriers to laterally shift to accommodate wheelchairs that have entered into the station 10 off center or skewed. In the wheelchair secured position, the lateral excursion barriers 30 apply a compressive force to the wheelchair in the range of about 40 to 75 lbs per side, for a total of 80 to 150 lbs. A lesser force may be sufficient for heavier wheelchairs, which have greater inertia, but may not be sufficient to restrain lighter wheelchairs. A greater force obviously would adequately restrain a wheelchair, regardless of whether it is heavy or light, but at the risk of potentially damaging the wheelchair or injuring the wheelchair passenger or other bystanders if, for example, a hand or other body part finds its way between the hands 36 and the wheelchair. It is preferable, but not essential, that the compressive or gripping force applied by the right shoulder 60a and the left shoulder 60b to the wheelchair be applied by a pneumatic system in which a common source of compressed air supplies each of the opposing sides, i.e., the right shoulder and the left shoulder, to ensure that balanced forces are applied to the wheelchair. By using a common source of compressed air to supply the driving force for both the right shoulder and the left shoulder, the wheelchair will be less likely to move during the process of being secured, and it is more likely that a good and secure grip will be made on the wheelchair.

Although the wheelchair release sequence is not described in detail herein, it is intended that the wheelchair release sequence would proceed substantially similar to the wheelchair securement sequence (as described above), except of course in reverse order.

Reference is now made of FIGS. 7A-7D. As described above, in their lowered, generally horizontal position, the hands 36 of the lateral excursion barriers 30 provide a relatively broad expanse. The broad expanse of the hands 36 along the longitudinal axis of the vehicle allows the wheelchair passenger station 10 to be compatible with many different sizes, types and designs of wheelchairs. FIGS. 7A-7D are intended to shows several of the many different kinds of wheelchairs that can be used with the shown embodiments of the wheelchair passenger station. In each instance, the hands 36 are able to snugly engage with the wheelchairs, regardless of the wheel size and position.

Turning now to FIG. 8, an exemplary operator control and monitoring panel 50 is shown that may be installed at or within arms reach of the drivers station of the vehicle. The panel 50 may include one or more video monitors that provide video images from one or more cameras that are installed on or near the wheelchair passenger station. In the shown embodiment, two video monitors 51a/b are provided that are connected to two video cameras, one on the upper backrest 26 looking towards the back of the vehicle and one on the ceiling of the vehicle looking downward on the wheelchair passenger station 10. The video monitors conveniently provide the operator with visual confirmation that the wheelchair passenger is properly positioned within the station 10, before the wheelchair securement sequence is initiated. The panel 50 preferably is provided with an emergency stop button 52, an operating mode toggle switch 53, a park/wheelchair ready push button 54, a wheelchair securement push button 55, a wheelchair release push button 56, a system fault/reset button 57, a stop request indicator 58, and an on/off toggle switch 59. Many of the push buttons are illuminated, including the park/wheelchair ready push button 54, the wheelchair securement push button 55, the wheelchair release push button 56, and the system fault/reset button 57, to give an indication regarding the status or configuration of the wheelchair passenger station 10. As an alternative to the panel 50 as shown, a touch screen panel commonly used in the control industry could be used, although not shown.

The operating mode toggle switch 53 allows the operator to switch between passenger control mode, in which the passenger initiates the wheelchair securement and wheelchair release sequences, and the driver assist mode, in which the driver initiates the wheelchair securement and release mode. When the station 10 is in the park position, none of the buttons will be illuminated.

When a wheelchair passenger is about to enter the vehicle, the vehicle operator will push the park/ready button to configure the station in the wheelchair ready position. This step will be performed irregardless of whether switch 53 is toggled to the passenger control or driver assist mode. When the station 10 is moving from the park position to the wheelchair ready position, the park/ready button 54 will blink on and off. When the station 10 arrives at the wheelchair ready position, the park/ready button 54 will stop blinking, but will remain illuminated.

In the driver assist mode, once the wheelchair passenger is properly position with his/her back against the forward excursion barrier, the operator will press button 55 (after visually confirming proper orientation of the wheelchair on the video monitors 51a/b) to configure the station 10 in the wheelchair secured position. Once pressed, the button 55 will blink on and off until the wheelchair is fully secured, after which the button 55 will be solidly illuminated. When the passenger wishes to exit the vehicle, he/she will press a button which will illuminate the stop request indicator 58. Once the vehicle is fully stopped and taken out of gear, the operator will press button 56 to release the wheelchair. The release button 56 will blink on and off until the station 10 enter the wheelchair ready position, after which the park/ready button 54 will illuminate. The wheelchair passenger will be free at that point to exit the vehicle. After the wheelchair passenger exits the station 10, the operator will then press the park/ready button 54 again, which will move the station 10 from the wheelchair ready position to the park position. During the phase, the button 54 will blink on and off until the park position is reached, after which the illuminated button 54 will remain off.

At any point during this process, if an emergency condition presents itself, the operator can press the emergency stop button in which case the wheelchair securement/release sequences will be terminated and the lateral excursion barriers 30 will be released such that they can be manually moved. The system fault button 57 will illuminate, and the operator can reset the system by pressing button 57.

During the wheelchair securement and release sequences, the passengers will receive audible warnings via speaker 12 and beeper (not shown) and visual warnings via warnings lights 40. The warning lights 40 will remain illuminated (possibly flashing) during the entire wheelchair securement sequence until the wheelchair is properly secured. The warning lights 40 will again illuminate when the wheelchair release sequence is initiated, and will remain illuminated until the station 10 is returned to the park position. Prior to each movement of the station 10, an audible warning will be provided.

Turning now to FIG. 9, a wheelchair passenger control panel 70 is provided, that includes at least two buttons. The first button 70, is used as a stop request when the station 10 is toggled via switch 53 in the driver assist mode, and is used to initiate the wheelchair securement sequence and wheelchair release sequence when the station 10 is togged to the passenger control mode. The second button is an emergency release button 74, and functions in much that same way as button 52 on the operator's control panel 50. The panel 70 is intended to be located within reach of the wheelchair passenger, and preferably under a side folding seat, if present.

Turning now to FIGS. 10-15, the internal mechanisms for operating and controlling the station 10 are shown along with a pneumatic line and system level architecture diagrams. Although only brief discussions of the mechanisms and diagrams are provided herein, it is understood that persons of ordinary skill in the art to which this application pertains would readily understand how the wheelchair passenger station 10 functions from the figures presented.

With reference to FIG. 10, in particular, a cross-section of the station 10 is provided to reveal the mechanism 80 for extending and refracting the shoulders 60. Within the shoulders 60, and extending through supporting collars or bearings 21 on opposite sides of the forward excursion barrier 20, is a central tube 82. Within the central tube is a central hub 84 having a plurality of interlacing rods (or in the alternative square tubes with roller and thrush bearings to support them) 86, some extending from the hub 84 to the right arm 34a and some extending to the left arm 34b. Through the center of the hub extends an actuator, in this case a pneumatic cylinder 88, with one end connected to the right arm 34a and the other end connected to the left arm 34b. Although the shown embodiment includes a pneumatic (or air) cylinder 88, electric cylinders or other types of actuators could be used. It should be readily understood that extending the piston of the cylinder 88 causes shoulders 60 to extend, and refracting the piston of the cylinder 88 causes the shoulders to retract. The mechanism 80 is provided with telescoping inner extenders 87, 89, which extend from the central tube 82 to the arms 34. An annular passage is created between the inner extenders 87, 89 and the outer extenders 62, 64, 66 to allow passage of control lines (such as air supply lines) into the arm to power the hands 36. In that respect, the inner extenders 87, 89 separates and protects the control lines from the interlacing rods 86 and cylinder 88. A person of skill in the art would understand that the configuration of the interlacing rods 86 and the cylinder 88 allows the lateral barriers 30 to “float” and thereby accommodate securement of wheelchairs that are positioned off-center or skewed, to a certain degree.

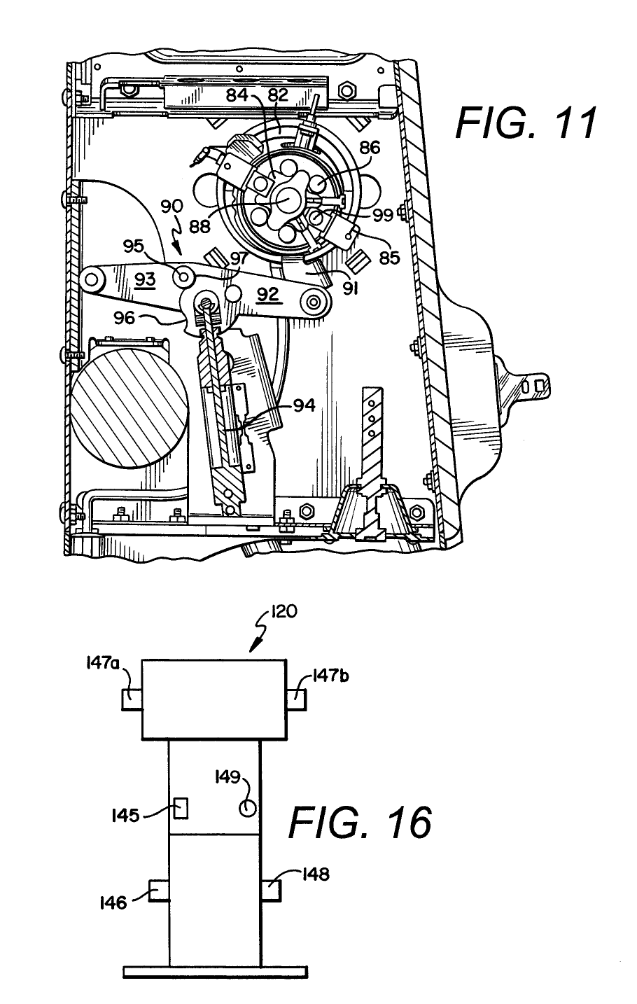

With reference briefly to FIG. 11, mechanism 80 is provided with a plurality of lock drivers 85, in this case a locking air cylinder, which cause locking plates 99 to engage with the interlacing rods 86. The lock drivers 85 used work on the same principle as a screen door simple hold open mechanism or bar clamp. Rather than rely upon the cylinder 88 to maintain compressive forces on the wheelchair, these locks are used to hold the lateral excursion barriers in the wheelchair secured mode. The system shown in the figures uses up to three locking plates, which are held vertical during normal operation and are tilted during the locking operation. The principle in use on the round interlacing rods 86 as shown can also be used on square tubes, if used. The use of locks in conjunction with the interlacing rods 86 ensures that the shoulders cannot extend, thus holding the wheelchair in position and not letting the shoulders float side to side. The lock drivers 85, as shown, are spring load return cylinders meaning that if the vehicle has an emergency situation and loses air, the cylinders return to their normal state and the rod locks would release automatically to ensure that the passenger could get out. Not shown are shoulder extend assist cylinders to push the shoulders apart if the system loses air to better assist in this operation. Also not shown are return assist cylinders on the hands to move them out of the way to better assist the passenger in getting out in an emergency situation in conjunction with the system losing air pressure. A delay release valve, also not shown, would let the shoulders open up first and then allow the hands to retract out of the way. As a side note, it has been found that during the wheelchair securement sequence, more secure engagement between the wheelchair and the station 10 can be obtained by engaging the locks after sufficient compression is obtained, while at the same time maintaining air pressure to the cylinder. The locks would then be released for several seconds, and then permanently reengaged. It has been found that this procedure allows the system to settle and more securely engage the wheelchair.

Turning back to FIG. 10, an air reservoir 130 is shown which works in conjunction with a backup battery system (not shown) to provide backup air/power in the event of a failure. It is contemplated that alternative embodiments of the station 10 could include its own compressor, such that the station 10 could be independent of the vehicle pneumatic system.

With reference again to FIG. 11, a second cross-section of the station 10 is provided to reveal the mechanism 90 for rotating the shoulders 60. The mechanism comprises an actuator operated linkage mechanism that provides over-center toggle locks for when the arms 34 are fully rotated back and fully rotated forward. Linkage 91 is fixed at one end to the center tube 82, and at an opposite end is pivotally attached to linkage 92. Linkage 92 is pivotally attached at its opposite end to both the piston of actuator (pneumatic cylinder) 94 and linkage 93, both about the same pivot axis. Linkage 93 is pivotally attached at its opposite end to the frame structure for the forward excursion barrier 20. One of ordinary skill in the art will understand that extension of the piston from the cylinder 94 will cause the central tube 82 to rotate clockwise (pulling the arms back behind the forward excursion plane 29), and retraction of the piston into the cylinder 94 will cause the central tube to rotate counter-clockwise (placing the arms in front of the forward excursion plane 29—towards the rear of the vehicle). Links 92 is provided with recesses or stops 96, 97 which are adapted to engage with pin 95 on linkage 93 to prevent over rotation of the arms 34 and to facilitate the creation of an over-center toggle lock, whereby the linkage mechanism holds the arms in the extended or refracted rotative position, as opposed to the cylinder 94 itself.

Turning now to FIG. 12, a side view of the station 10 is provided with the cover panel of the right arm 34a removed to reveal the mechanism 100 that raises and lowers the hand 36a. The mechanism essentially comprises three cams (or tracks) 40, that engage with cam followers 102, 104, and 106 that are rigidly attached to and extend from the outer surface of the hands 36. An actuator (in this case, a pneumatic cylinder) 108 is fixed at one end to the upper end of the arm 34, and at the other end to cam follower 106. One of ordinary skill in the art would understand that retraction of the piston into the cylinder 108 will cause the hand 36 to move from its lowered, generally horizontal position to its raised, generally vertical position. Likewise, extension of the piston from the cylinder 108 will cause the hand 36 to move from its raised (or stored) position to its lowered (or extended) position. As the hands 36 move between the raised and lowered position, the path of the cams 40 cause the hands 36 to move both linearly and rotatively.

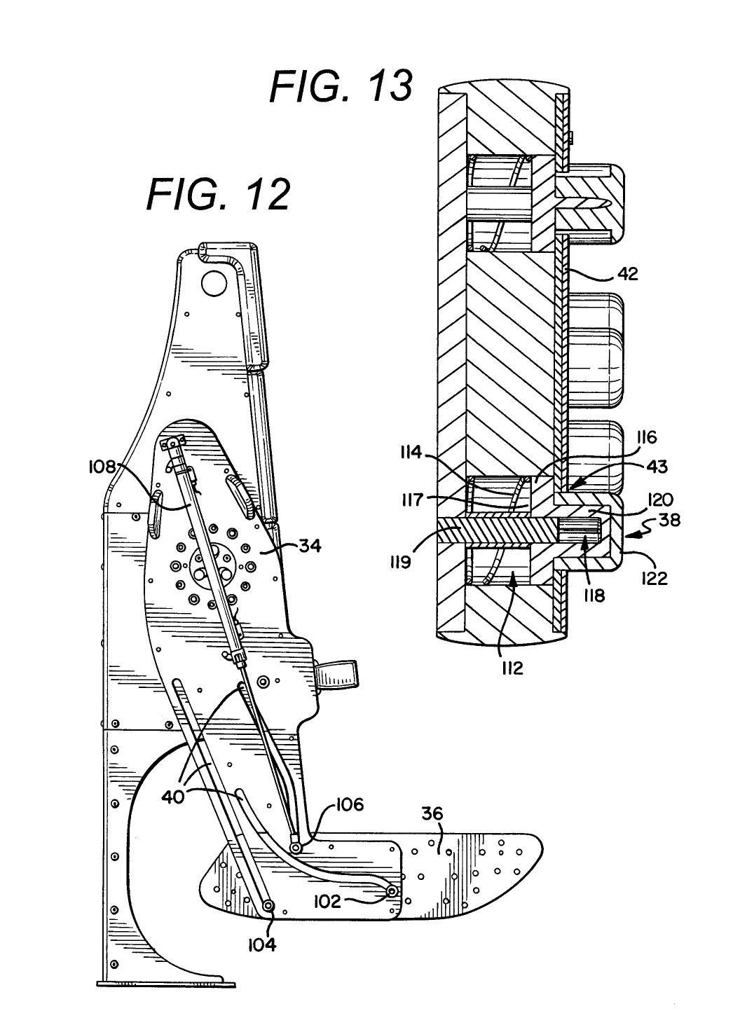

With reference now to FIG. 13, a cross section of the left hand 36b is provided passing through the lower finger 38 through its centerline. FIG. 13 reveals the mechanism 110 for biasing the fingers 38 in their extended position. The mechanism comprises a main bore 112 in the hand in which a biasing member (in this case, a coiled spring) 114 is placed. The finger 38 itself has an increased diameter near its base 116 which corresponds with the diameter of the bore 112. The palm 42 provides a plurality of apertures 43, allowing the free ends of the fingers 38 to pass therethrough, but not the base 116. The base end 118 of the fingers 38 includes a blind hole 118, into which a guide pin 119 extends. In the shown embodiment, the guide pin is a steel dowel pin, although other rigid materials may be used. The guide pin is aligned concentrically with the bore 112 and is fixed to the outer wall of the hand 36. The guide pin 119 engages with the finger 38 to include planar movement. As shown, the spring 114 bears on the base end 117 of the finger 38, to push the finger in its extended position.

The fingers 38 are preferably formed from a two piece extrusion with a hard plastic internal structure 120, such as Delron, and a soft plastic external surface 122, such as 80-90 derometer velcronized rubber, which provides grip. Note that the fingers have grooves at the base and in the pilot hole to release trapped air. It has been determined that the structure of the finger 38 should be capable of withstanding a sheer force of 535 lbf to adequately secure a wheelchair.

When a wheelchair is secured, it is expected that the fingers 38 will firmly engage, but not damage the wheelchair. It is intended that the wheelchair will be restrained by both friction and interference. Being that the fingers 38 are spring biased in the outward position, the fingers will follow the contour of the wheelchair, and some fingers 38 will find themselves in crevasses; for example, some fingers 38 will be disposed between wheel spokes. Such interference aids in wheelchair restraint, since the fingers 38 would be able to effectively resist wheel rotation and longitudinal movement of the wheelchair.

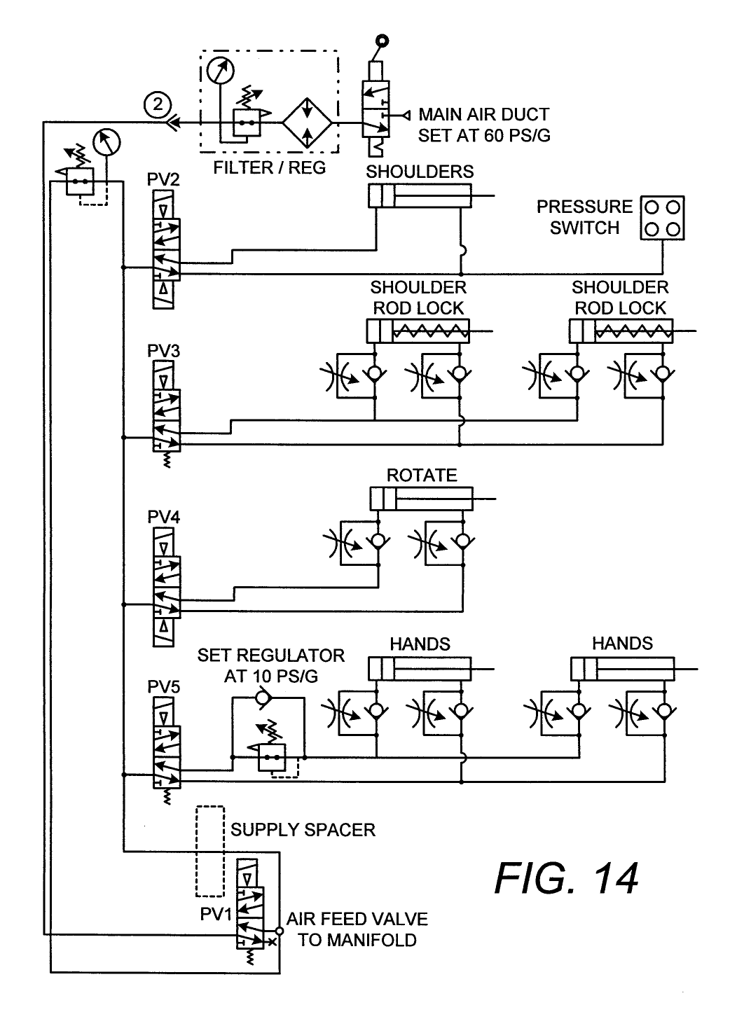

Turning now to FIG. 14, a pneumatic circuit diagram is provided which is readily understood by one of ordinary skill in the art. Of note is that a free flow reverse regulator is provided for manipulating the hands. The use of a free flow reverse regulator was found beneficial because the effects of gravity dictates that greater force is required to raise the hands 36 to their storage/park position that is required to lower the hands 36 to their use position. In addition, a pressure switch is provided to sense when the wheelchair is adequately captured by the lateral barriers 30.

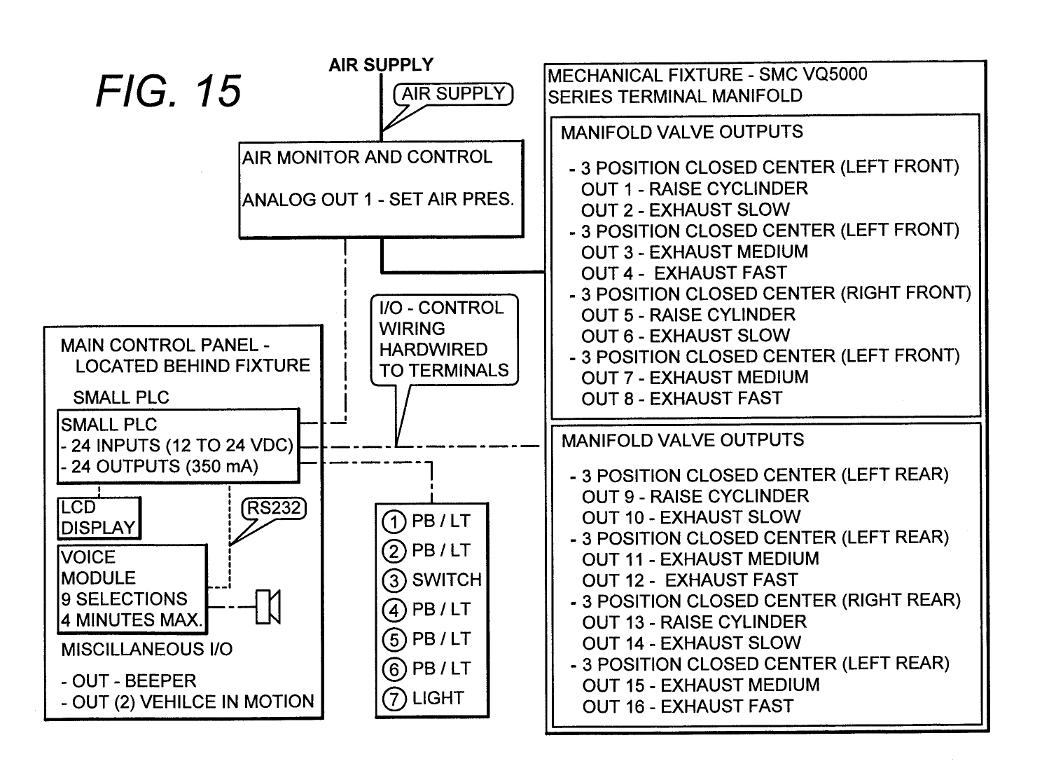

Finally, with reference to FIG. 15, a system level architecture diagram is provided showing the use of a programmable logic controller (PLC) or embedded processor which communicates with various components of the station 10. The PLC or embedded processor controls the operation of the system and controls the inputs and outputs noted. The PLC or embedded controller will control the valve manifold or electric drives (in an alternative embodiment) to extend and retract all cylinders. The PLC or embedded processor also controls the lights, voice messages communication, and monitors sensors. Of note is that the PLC will be programmed to provide multi-language voice instructions. Additionally, the PLC software will be programmed to detect problems by keeping track of the amount of time it takes for the various components to reach desired positions. Proximity switches would be used to verify when the various components reach their extended and refracted positions. The PLC will provide a fault indication to the vehicle operator if any particular sequence takes too long. The PLC preferably uses a rotating histogram to adjust reference times (the amount of time it should take for any component to move between desired positions) based upon the number of operations and/or temperature to account for wear and tear. Also, the PLC software will be programmed to track and store in memory the number of operations, the amount of time the unit has been powered up, and the number of emergency stops and fault conditions. This information could potentially be used for diagnosing problems, for various warranty purposes, and/or for future product development. The software also uses fuzzy logic based on the data gathered by the system. For instance, if the system is detecting a cold day, time fault timers will increase to prevent a false fault condition, giving the actuators more time to move in the cold condition. The same holds true as the system ages, since the times might tend to increase due to mechanical wear and the program will automatically adjust the fault timers or other parts of the program to accommodate the changing environment.

Connecting into the vehicle systems is possible, but not shown because of the variety of different networks. The interlocking system (i.e., vehicle in drive or park) is not shown because of the variety of different systems that would be interfaced. However, a person of ordinary skill in the art would understand and know how to connect thereto.

Turning now to FIG. 16, a second embodiment of a forward excursion barrier 120 is shown, although the depending lateral excursion barriers have been removed for purposes of clarity. The second embodiment of the forward excursion barrier 120 includes alternate positioning of the occupant safety belts 146, 148. Instead of being located on the lateral barriers, the female and male connectors 146, 148 are connected to the forward excursion barrier 120. In the particular embodiment shown, the connectors 146, 148 are positioned on the sides and towards the lower end of the forward excursion barrier 120, although the connectors could be positioned on a front face thereof. In addition, the second embodiment includes one or more shoulder belts 147a or 147b. In the particular embodiment shown, the shoulder belt 147a or 147b is mounted to or extends from the side of the forward excursion barrier, although the belt could alternately mount to or extend from a front face thereof.

The second embodiment of the forward excursion barrier is also adapted for restraining a segway. The wheels of the segway would be secured by the lateral barriers in the same manner as described above, however an additional restraint system is provided to restrain the handle of the segway. In the particular embodiment shown in FIG. 16, a restraint 145 would extend from forward excursion barrier 120. For the shown embodiment, it is contemplated that the restraint would be an internally mounted refractor, from which a restraint strap or belt would extend. The restraint belt would be pulled and wrapped around the handle of the segway, and the terminal end of the belt would engage a loop connector 149 (or any other type of connector) that is also provided on the forward excursion barrier 120.

Although the inventions described and claimed herein have been described in considerable detail with reference to certain embodiments, one skilled in the art will appreciate that the inventions described and claimed herein can be practiced by other than the embodiments shown herein, which have been presented for purposes of illustration and not of limitation. Therefore, the spirit and scope of the appended claims should not be limited to the description of the embodiments shown and described herein.

We claim:

1. A wheelchair securement device for a transport vehicle, the wheelchair securement device comprising:
an area for receiving a wheelchair in a rearward facing orientation relative to the transport vehicle;
a forward excursion barrier which is adapted to restrain movement of the wheelchair toward the front of the vehicle, a substantial portion of the forward excursion barrier being positioned behind the wheelchair when the wheelchair is properly positioned for securement;
a first lateral barrier and a second lateral barrier being directly attached to opposing sides of the forward excursion barrier; and,
the first and second lateral barriers being adapted to engage with the wheelchair by compression whereby the first lateral barrier contacts at least a portion of a first side of the wheelchair and the second lateral barrier contacts at least a portion of a second side of the wheelchair.

2. The wheelchair securement device of claim 1, wherein the forward excursion barrier defines a forward excursion plane, the first and second lateral barriers being movable between a park position and a wheelchair engaged position, and a substantial portion of the first and second movable wheelchair engaging supports being positioned behind the forward excursion plane, towards the front of the vehicle, when placed in the park position, to allow for lateral access into the wheelchair device from an aisle of the vehicle.

3. The wheelchair securement device of claim 1, wherein an actuator is interposed between the first lateral barrier and the second lateral barrier, whereby the first lateral barrier and the second lateral barrier are configured to move laterally.

4. The wheelchair securement device of claim 1, wherein the first and second lateral barriers comprise shoulder members, arm members, and hand members, the shoulder members extending from opposing sides of the forward excursion barrier, the arm members depending from the shoulder members, and the hand members depending from the arm members.

5. The wheelchair securement device of claim 4, wherein the shoulder members are configured to extend and refract, the arm members are configured to rotate, and the hand members are configured for sliding and rotating movements relative to the arm members.

6. The wheelchair securement device of claim 4, wherein the hand member further includes a plurality of finger members.

7. The wheelchair securement device of claim 6, wherein the finger members are moveable between refracted and extended positions.

8. The wheelchair securement device of claim 7, wherein a plurality of biasing members are interposed between the hand members and the finger members to bias the finger members in the extended positions.

9. The wheelchair securement device of claim 6, wherein the finger members are adapted to engage with a wheelchair by both friction and interference.

10. The wheelchair securement device of claim 4, wherein the first and second lateral barriers have a park position and a wheelchair engaged position.

11. The wheelchair securement device of claim 10, wherein the hand members engage a recess fixed to the vehicle when the first and second lateral barriers are configured in the park position.

12. The wheelchair securement device of claim 5, wherein a first actuator is used to extend and retract the shoulder members of the first and second lateral barriers, a second actuator is used to rotate the arm members of the first and second lateral barriers, a third actuator is used to move the hand member of the first lateral barrier, and a fourth actuator is used to move the hand member of the second lateral barrier.

13. The wheelchair securement device of claim 12, wherein the first actuator extends through the shoulder members and is attached at a first end to the arm member of the first lateral barrier and at a second end to the arm member of the second lateral barrier.

14. The wheelchair securement device of claim 12, wherein the second actuator works in conjunction with an over-center toggle mechanism to rotate the arm members between a refracted position and an extended position.

15. The wheelchair securement device of claim 12, wherein the third and fourth actuators work in conjunction with a plurality of cams and cam followers to impart sliding and rotating movements to the hand members.

16. A wheelchair securement device for a transport vehicle, the wheelchair device comprising:
a first lateral barrier for engaging with a first side of a wheelchair and a second lateral barrier for engaging with a second side of the wheelchair;
the first lateral barrier being movable towards the second barrier whereby the first and second lateral barriers engage with the wheelchair by compression;
a driver for moving the first lateral barrier towards the second lateral barrier; and,
a lock for holding the first lateral barrier in compressive engagement with the wheelchair.

17. A wheelchair securement device for a transport vehicle, the wheelchair securement device comprising:
an area for receiving a wheelchair;
a first lateral barrier and a second lateral barrier being configured for squeezing engagement with a wheelchair; and,
the first lateral barrier being positioned adjacent an aisle of the vehicle and comprising a first member and a second member, the second member depending from the first member; and,
both the first and second member being movable between a retracted position and a use position, whereby positioning the first and second members in the refracted position permits lateral access into the wheelchair device from the aisle of the vehicle.
